(19) United States
(12) Patent Application Publication
(10) Pub. No.: US 2026/0322759 A1
(43) Pub. Date: Oct. 15, 2026

(54) MANAGING COMMUNICATIONS FOR SESSIONS INITIATED BY HOST DEVICES WHICH ARE PART OF A MULTI-HOST LINK AGGREGATION GROUP

(71) Applicant: Dell Products L.P., Round Rock, TX (US)

(72) Inventors: Jianfei Yang, Chengdu (CN); Xiaofeng Ge, Chengdu (CN); Si Zhang, Chengdu (CN); Mingyi Luo, Chengdu (CN); Lifeng Zheng, Chengdu (CN)

(21) Appl. No.: 19/193,092

(22) Filed: Apr. 29, 2025

(30) Foreign Application Priority Data
Apr. 14, 2025 (CN) 202510462035.5

(51) Int. Cl. H04L 47/41; H04L 47/125

(52) U.S. Cl. CPC H04L 47/41; H04L 47/125

(57) ABSTRACT

An apparatus comprises at least one processing device configured to receive, by a network switch, a communication to be distributed utilizing a link aggregation bond coupling the network switch to a multi-host link aggregation bond associated with a plurality of host devices sharing a common network address. The at least one processing device is also configured to determine, utilizing a session store, whether the communication belongs to a session initiated by any of the host devices. The at least one processing device is further configured, responsive to determining that the communication belongs to a session initiated by a given one of the host devices, to retrieve a port number associated with the given host device from the session store and to distribute the communication to the given host device utilizing the retrieved port number.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATION

The present application claims priority to Chinese Patent Application No. 202510462035.5, filed on Apr. 14, 2025 and entitled “Managing Communications for Sessions Initiated by Host Devices which are part of a Multi-Host Link Aggregation Group,” which is incorporated by reference herein in its entirety.

### BACKGROUND

Information processing systems often include distributed arrangements of multiple nodes, also referred to herein as distributed processing systems. Such systems can include, for example, distributed storage systems comprising multiple storage nodes. These distributed storage systems are often dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. Data within the system is partitioned, striped, and replicated across the distributed storage nodes. For a storage administrator, the software-defined storage system provides a logical view of a given dynamic storage pool that can be expanded or contracted at ease, with simplicity, flexibility, and different performance characteristics. For applications running on a host device that utilizes the software-defined storage system, such a storage system provides a logical storage object view to allow a given application to store and access data, without the application being aware that the data is being dynamically distributed among different storage nodes potentially at different sites.

### SUMMARY

Illustrative embodiments of the present disclosure provide techniques for managing communications for sessions initiated by host devices which are part of a multi-host link aggregation group.

In one embodiment, an apparatus comprises at least one processing device comprising a processor coupled to a memory. The at least one processing device is configured to receive, by at least one network switch, a communication to be distributed utilizing a link aggregation bond coupling the at least one network switch to a multi-host link aggregation bond associated with a plurality of host devices sharing a common network address. The at least one processing device is also configured to determine, utilizing a session store maintained by the at least one network switch, whether the communication belongs to a session initiated by any of the plurality of host devices that are part of the multi-host link aggregation bond. The at least one processing device is further configured, responsive to determining that the communication belongs to a session initiated by a given one of the plurality of host devices that is part of the multi-host link aggregation bond, to retrieve a port number associated with the given host device from the session store and to distribute the communication to the given host device utilizing the retrieved port number. The at least one processing device is further configured, responsive to determining that the communication does not belong to a session initiated by any of the plurality of host devices that are part of the multi-host link aggregation bond, to select one of the plurality of host devices in accordance with a distribution algorithm and to direct the communication to the selected one of the plurality of host devices.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for managing communications for sessions initiated by host devices which are part of a multi-host link aggregation group in an illustrative embodiment.

FIG. 2 is a flow diagram of an exemplary process for managing communications for sessions initiated by host devices which are part of a multi-host link aggregation group in an illustrative embodiment.

FIG. 3 shows a system configured for implementing load balancing for client/server communications in an illustrative embodiment.

FIG. 4 shows a system configured for implementing an anycast model for client/server communications in an illustrative embodiment.

FIG. 5 shows a service and associated service Internet Protocol address and virtual bond provided by a cluster of host devices which are part of a multi-host link aggregation bond in an illustrative embodiment.

FIG. 6 shows a system configured for implementing link aggregation in an illustrative embodiment.

FIG. 7 shows a system including a network switch configured with a customized link distribution algorithm for distributing network frames among a cluster of host devices which are part of a multi-host link aggregation bond with each of the host devices in the cluster being configured with a first virtual local area network logical device for server-initiated communications and a second virtual local area network logical device for client-initiated conversations in an illustrative embodiment.

FIG. 8 shows a system configured with physical and virtual network switches configured with a customized link distribution algorithm for distributing network frames among a cluster of host devices which are part of a multi-host link aggregation bond in an illustrative embodiment.

FIG. 9 shows a system implementing a virtualization environment supporting a multi-host link aggregation bond in an illustrative embodiment.

FIG. 10 shows a header format utilized for packets or frames of cluster-initiated conversations for a cluster of host devices in an illustrative embodiment.

FIG. 11 shows an architecture of a B-tree forest structure and doubly-linked list for use in managing cluster-initiated conversations for a cluster of host devices in an illustrative embodiment.

FIG. 12 shows a process flow for constructing a session store maintaining information for cluster-initiated conversations for a cluster of host devices in an illustrative embodiment.

FIG. 13 shows a process flow for querying and updating a session store maintaining information for cluster-initiated conversations for a cluster of host devices in an illustrative embodiment.

FIG. 14 shows a process flow for inserting a node in a session store maintaining information for cluster-initiated conversations for a cluster of host devices in an illustrative embodiment.

FIG. 15 shows a process flow for checking for and removing timed-out conversations in a session store maintaining information for cluster-initiated conversations for a cluster of host devices in an illustrative embodiment.

FIG. 16 shows pseudocode for defining a session store and nodes thereof representing cluster-initiated conversations for a cluster of host devices in an illustrative embodiment.

FIG. 17A shows pseudocode for implementing a process flow for constructing a session store maintaining information for cluster-initiated conversations for a cluster of host devices in an illustrative embodiment.

FIG. 17B shows pseudocode for implementing a process flow for querying and updating a session store maintaining information for cluster-initiated conversations for a cluster of host devices in an illustrative embodiment.

FIG. 17C shows pseudocode for implementing a process flow for inserting a node in a session store maintaining information for cluster-initiated conversations for a cluster of host devices in an illustrative embodiment.

FIG. 17D shows pseudocode for implementing a process flow for checking for and removing timed-out conversations in a session store maintaining information for cluster-initiated conversations for a cluster of host devices in an illustrative embodiment.

FIGS. 18 and 19 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

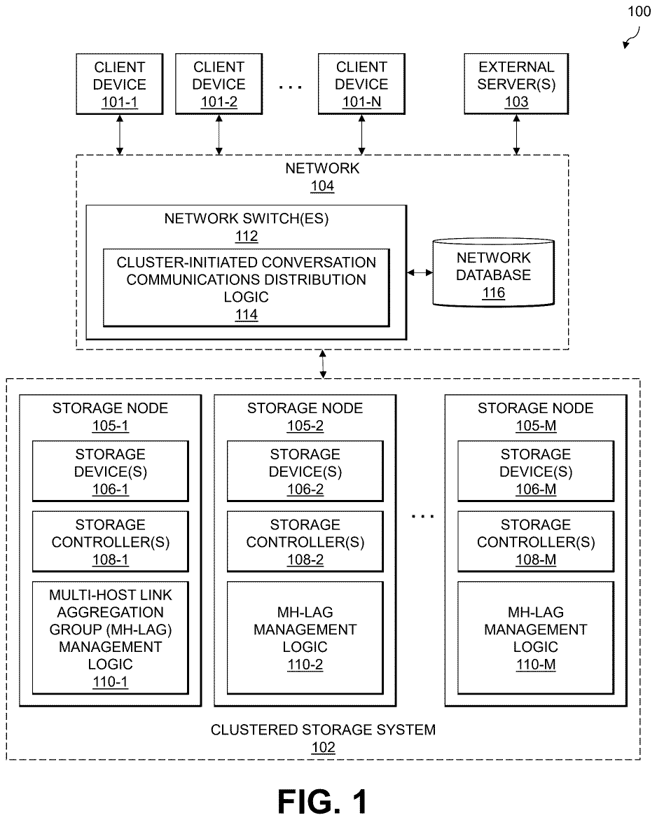

FIG. 1 shows an information processing system 100 configured in accordance with an illustrative embodiment. The information processing system 100 comprises a plurality of client devices 101-1, 101-2, . . . 101-N (collectively, client devices 101), a clustered storage system 102 and one or more external servers 103. The clustered storage system 102 is an example of what is more generally referred to herein as a distributed storage system or more generally a distributed processing system, which may include a combination of one or more compute and storage nodes. The client devices 101, the clustered storage system 102 and external servers 103 are configured to communicate with one another via a network 104 that illustratively utilizes protocols such as Transmission Control Protocol (TCP) and/or Internet Protocol (IP), and may therefore be referred to herein as a TCP/IP network, although it is to be appreciated that the network 104 can operate using additional or alternative protocols. In some embodiments, the network 104 comprises a storage area network (SAN) that includes one or more Fibre Channel (FC) switches, Ethernet switches or other types of switch fabrics. As shown in FIG. 1, the network 104 comprises one or more network switches 112 (also referred to herein as network devices, or network switch devices).

The clustered storage system 102 more particularly comprises a plurality of storage nodes 105-1, 105-2, . . . 105-M (collectively, storage nodes 105). The values N and M in this embodiment denote arbitrary integer values that in the figure are illustrated as being greater than or equal to three, although other values such as N=1, N=2, M=1 or M=2 can be used in other embodiments. Similarly, the values C, S, h, n used in other embodiments denote arbitrary integer values.

The storage nodes 105 collectively form the clustered storage system 102, which is just one possible example of what is generally referred to herein as a “distributed storage system.” Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the clustered storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105.

Other types of distributed storage systems can be used in other embodiments. For example, the clustered storage system 102 can comprise multiple distinct storage arrays, such as a production storage array and a backup storage array, possibly deployed at different locations. Accordingly, in some embodiments, one or more of the storage nodes 105 may each be viewed as comprising at least a portion of a separate storage array with its own logical address space. Alternatively, the storage nodes 105 can be viewed as collectively comprising one or more storage arrays. The term “storage node” as used herein is therefore intended to be broadly construed.

In some embodiments, the clustered storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments.

The client devices 101 illustratively comprise servers or other types of computers of an enterprise computer system, cloud-based computer system or other arrangement of multiple compute nodes associated with respective users.

The client devices 101 in some embodiments illustratively provide compute services such as execution of one or more applications on behalf of each of one or more users associated with respective ones of the client devices 101. Such applications illustratively generate input-output (IO) operations that are processed by the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms.

Each of the storage nodes 105 is illustratively configured to interact with one or more of the client devices 101 and/or the external servers 103. Communications which are initiated by the client devices 101 towards the storage nodes 105 are referred to as “client-initiated” conversations, while communications which are initiated by the storage nodes 105 in the clustered storage system 102 towards the external servers 103 (or, possibly, the client devices 101) are referred to as “server-initiated” or “cluster-initiated” conversations. The client devices 101, for example, may be configured to write data to and read data from the clustered storage system 102 comprising the storage nodes 105 in accordance with applications executing on those client devices 101 for system users. The storage nodes 105 of the clustered storage system 102, for example, may be configured to access the external servers 103 for authentication/authorization, for time synchronization, etc.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over the network 104, which may include a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. Various communication protocols, including but not limited to TCP/IP communication protocols, may be used for communication among the components of the system 100 over network 104 or one or more additional networks.

As a more particular example, some embodiments may utilize one or more high-speed local networks in which associated processing devices communicate with one another utilizing Peripheral Component Interconnect express (PCIe) cards of those devices, and networking protocols such as InfiniBand or Gigabit Ethernet, in addition to or in place of FC. Numerous alternative networking arrangements are possible in a given embodiment, as will be appreciated by those skilled in the art. Other examples include remote direct memory access (RDMA) over Converged Ethernet (RoCE) or InfiniBand over Ethernet (IBoE).

The first storage node 105-1 comprises a plurality of storage devices 106-1, one or more associated storage controllers 108-1, and multi-host link aggregation group (MH-LAG) management logic 110-1. The storage controllers 108-1 illustratively control read and/or write of data to the storage devices 106-1 (e.g., in response to IO requests which are received from one or more of the client devices 101 and/or one or more of the external servers 103). As will be described in further detail below, the storage node 105-1 is assumed to be part of a link aggregation group (e.g., a MH-LAG) with other ones of the storage nodes 105 in the clustered storage system 102. The link aggregation group may provide an Active/Active cluster configuration for the clustered storage system 102. The MH-LAG management logic 110-1 provides various functionality for the management of the link aggregation group, including but not limited to creation, modification and deletion of the link aggregation group or nodes which are members thereof, creation and management of addresses (e.g., IP addresses) and ports for facilitating both client-initiated and server-initiated conversations, etc.

Each of the other storage nodes 105-2 through 105-M is assumed to be configured in a manner similar to that described above for the first storage node 105-1. Accordingly, by way of example, storage node 105-2 comprises a plurality of storage devices 106-2, one or more associated storage controllers 108-2 and MH-LAG management logic 110-2, and storage node 105-M comprises a plurality of storage devices 106-M, one or more associated storage controllers 108-M and MH-LAG management logic 110-M.

Local persistent storage of a given one of the storage nodes 105 illustratively comprises particular local persistent storage devices that are implemented in or otherwise associated with that storage node. It is assumed that such local persistent storage devices of the given storage node are accessible to the storage controllers of that node via a local interface, and are accessible to storage controllers 108 of respective other ones of the storage nodes 105 via remote interfaces. For example, it is assumed in some embodiments disclosed herein that each of the storage devices 106 on a given one of the storage nodes 105 can be accessed by the given storage node via its local interface, or by any of the other storage nodes 105 via an RDMA interface. A given storage application executing on the storage nodes 105 illustratively requires that all of the storage nodes 105 be able to access all of the storage devices 106. Such access to local persistent storage of each node from the other storage nodes can be performed, for example, using the RDMA interfaces with the other storage nodes, although numerous other arrangements are possible.

The storage controllers 108 of the storage nodes 105 may include additional modules and other components typically found in conventional implementations of storage controllers and storage systems, although such additional modules and other components are omitted from the figure for clarity and simplicity of illustration.

The storage controllers 108 may be associated with one or more write caches and one or more write cache journals, both illustratively distributed across the storage nodes 105 of the clustered storage system 102. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include non-volatile random access memory (NVRAM), phase-change RAM (PC-RAM), magnetic RAM (MRAM), resistive RAM, spin torque transfer magneto-resistive RAM (STT-MRAM), etc. These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of storage devices 106 of the storage nodes 105 of the clustered storage system 102 of FIG. 1.

In some embodiments, the storage nodes 105 of the clustered storage system 102 collectively provide a scale-out storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the client devices 101 and the storage nodes 105 comprise NVMe commands of an NVMe storage access protocol, for example, as described in the NVMe Specification, Revision 2.0a, July 2021, which is incorporated by reference herein. Other examples of NVMe storage access protocols that may be utilized in illustrative embodiments disclosed herein include NVMe over Fabrics, also referred to herein as NVMeoF, and NVMe over TCP, also referred to herein as NVMe/TCP. Other embodiments can utilize other types of storage access protocols. As another example, communications between the client devices 101 and the storage nodes 105 in some embodiments can comprise Small Computer System Interface (SCSI) or Internet SCSI (iSCSI) commands.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

In some embodiments, the storage nodes 105 of the clustered storage system 102 of FIG. 1 are connected to each other in a full mesh network, and are collectively managed by a system manager. A given set of storage devices 106 on a given one of the storage nodes 105 is illustratively implemented in a disk array enclosure (DAE) or other type of storage array enclosure of that storage node. Each of the storage nodes 105 illustratively comprises a CPU or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, the storage nodes 105 in some embodiments are paired together in an arrangement referred to as a “brick,” with each such brick being coupled to a different DAE comprising multiple drives, and each node in a brick being connected to the DAE and to each drive through a separate connection. The system manager may be running on one of the two nodes of a first one of the bricks of the distributed storage system. Again, numerous other arrangements of the storage nodes are possible in a given distributed storage system as disclosed herein.

The clustered storage system 102 may further comprise one or more system management nodes (not shown) that are illustratively configured to provide system management functionality.

As indicated previously, the storage nodes 105 of the clustered storage system 102 process IO operations from one or more of the client devices 101. In processing those IO operations, the storage nodes 105 may run various storage application processes that may involve interaction between multiple ones of the storage nodes. Such IO operations are an example of what is more generally referred to herein as client-initiated conversations. The storage nodes 105 may also direct operations (e.g., authentication operations, authorization operations, time synchronization operations, etc.) to entities outside the clustered storage system 102, such as one or more of the external servers 103 and possibly one or more of the client devices 101. Such operations are examples of what is more generally referred to herein as server-initiated or cluster-initiated conversations.

In the FIG. 1 embodiment, the storage nodes 105 of the clustered storage system 102 comprise storage controllers 108 and corresponding sets of storage devices 106 along with MH-LAG management logic 110, and may include additional or alternative components.

The storage controllers 108 illustratively control the processing of IO operations received in the clustered storage system 102 from the client devices 101. For example, the storage controllers 108 illustratively manage the processing of read and write commands directed by the client devices 101 to particular ones of the storage devices 106. The storage controllers 108 can be implemented as respective storage processors, directors or other storage system components configured to control storage system operations relating to processing of IO operations. In some embodiments, each of the storage controllers 108 has a different local cache associated therewith, although numerous alternative arrangements are possible.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes.

Also, the term “storage volume” as used herein is intended to be broadly construed, and should not be viewed as being limited to any particular format or configuration.

In some embodiments, the storage nodes 105 are implemented using processing modules that are interconnected in a full mesh network, such that a process of one of the processing modules can communicate with processes of any of the other processing modules. Commands issued by the processes can include, for example, remote procedure calls (RPCs) directed to other ones of the processes.

The sets of processing modules of the storage nodes 105 illustratively comprise control modules, data modules, routing modules and at least one management module. Again, these and possibly other processing modules of the storage nodes 105 are illustratively interconnected with one another in the full mesh network, such that each of the modules can communicate with each of the other modules, although other types of networks and different module interconnection arrangements can be used in other embodiments.

The management module in such an embodiment may more particularly comprise a system-wide management module, also referred to herein as a system manager. Other embodiments can include multiple instances of the management module implemented on different ones of the storage nodes 105.

A wide variety of alternative configurations of nodes and processing modules are possible in other embodiments. Also, the term “storage node” as used herein is intended to be broadly construed, and may comprise a node that implements storage control functionality but does not necessarily incorporate storage devices. As mentioned previously, a given storage node can in some embodiments comprise a separate storage array, or a portion of a storage array that includes multiple such storage nodes.

Communication links may be established between the various processing modules of the storage nodes using communication protocols such as TCP/IP and RDMA. For example, respective sets of IP links used in data transfer and corresponding messaging could be associated with respective different ones of the routing modules.

The storage nodes 105 of the clustered storage system 102 implement MH-LAG management logic 110, which is configured to manage a MH-LAG including the storage nodes 105 of the clustered storage system 102. The MH-LAG may provide Active/Active cluster functionality. The MH-LAG management logic 110, for example, may be configured to generate MH-LAG bonds for the storage nodes 105, and to manage addresses and ports utilized for client-initiated and server-initiated conversations.

The network switches 112 in the network 104 interconnect the client devices 101, the external servers 103 and the storage nodes 105 of the clustered storage system 102. The network switches 112 are configured with cluster-initiated conversation communications distribution logic 114. The cluster-initiated conversation communications distribution logic 114 is configured to receive communications that are to be distributed (e.g., by the network switches 112 utilizing a link aggregation bond coupling the network switches 112 to a multi-host link aggregation bond associated with the storage nodes 105, where the storage nodes 105 that are part of the multi-host link aggregation bond share a common network address). The cluster-initiated conversation communications distribution logic 114 is also configured to determine, utilizing a session store maintained by the network switches 112 (e.g., in the network database 116), whether the communications to be distributed belong to sessions initiated by any of the storage nodes 105 that are part of the multi-host link aggregation bond. Responsive to determining that a given communication (e.g., a frame or packet) belongs to a session initiated by one of the storage nodes 105 that is part of the multi-host link aggregation bond, the cluster-initiated conversation communications distribution logic 114 is configured to retrieve from the session store a port number for that one of the storage nodes 105 and to distribute the given communication to that one of the storage nodes 105 utilizing the retrieved port number. Responsive to determining that the given communication does not belong to a session initiated by any of the storage nodes 105 that are part of the multi-host link aggregation bond, the cluster-initiated conversation communications distribution logic 114 is configured to select one of the storage nodes 105 that is part of the multi-host link aggregation bond in accordance with a distribution algorithm and to direct the given communication to the selected one of the storage nodes 105.

The particular features described above in conjunction with FIG. 1 should not be construed as limiting in any way, and a wide variety of other system arrangements providing functionality for security management for endpoint nodes of distributed processing systems are possible.

The storage nodes 105 of the example clustered storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated client devices 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the client devices 101 and the storage nodes 105 to reside in different data centers. Numerous other distributed implementations of the storage nodes 105 and their respective associated sets of client devices 101 are possible.

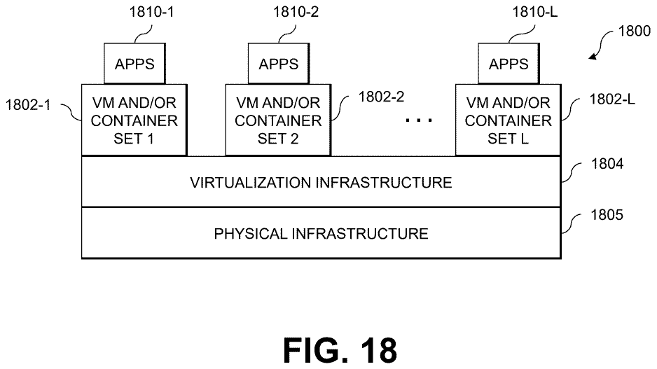

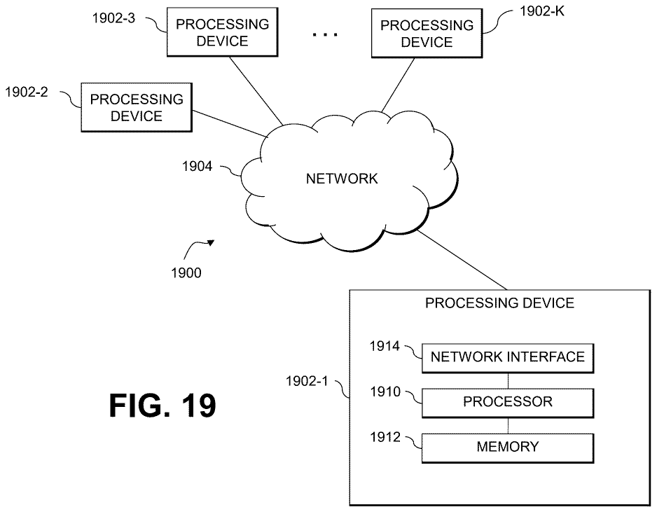

Additional examples of processing platforms utilized to implement storage systems and possibly their associated host devices in illustrative embodiments will be described in more detail below in conjunction with FIGS. 18 and 19.

It is to be appreciated that these and other features of illustrative embodiments are presented by way of example only, and should not be construed as limiting in any way.

Accordingly, different numbers, types and arrangements of system components such as client devices 101, clustered storage system 102, storage nodes 105, storage devices 106, storage controllers 108, MH-LAG management logic 110, network switches 112, cluster-initiated conversation communications distribution logic 114 and network database 116 can be used in other embodiments.

It should be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in some embodiments, certain portions of the functionality for managing communications for sessions initiated by host devices which are part of a multi-host link aggregation group as disclosed herein may be implemented through cooperative interaction of one or more host devices, one or more storage nodes of a distributed storage system, and/or one or more system management nodes. Accordingly, such functionality can be distributed over multiple distinct processing devices. The term “at least one processing device” as used herein is therefore intended to be broadly construed.

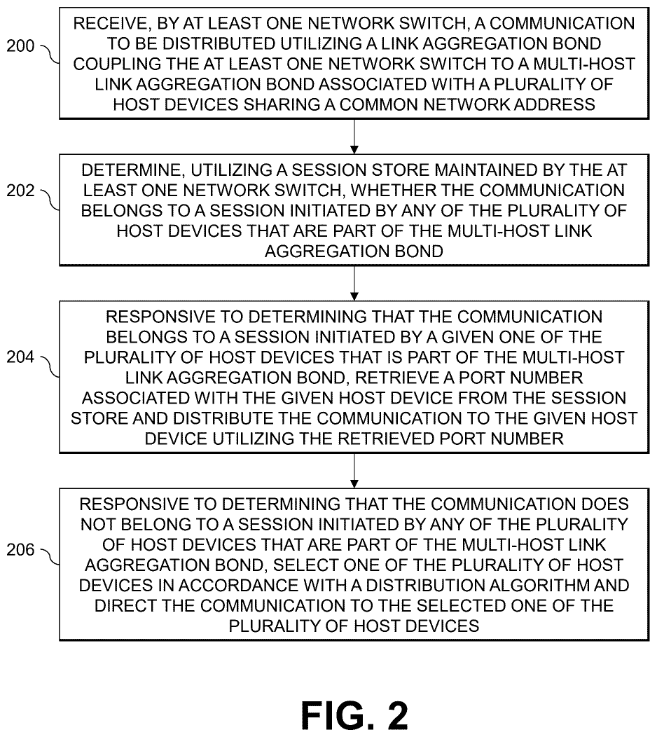

The operation of the information processing system 100 will now be described in further detail with reference to the flow diagram of the illustrative embodiment of FIG. 2, which illustrates a process for managing communications for sessions initiated by host devices which are part of a multi-host link aggregation group. This process may be viewed as an illustrative example of an algorithm implemented at least in part by one or more of the storage nodes 105 and/or one or more of the network switches 112 utilizing corresponding instances of the MH-LAG management logic 110 and cluster-initiated conversation communications distribution logic 114. These and other algorithms for managing communications for sessions initiated by host devices which are part of a multi-host link aggregation group as disclosed herein can be implemented using other types and arrangements of system components in other embodiments.

The process illustrated in FIG. 2 includes steps 200 through 206. In step 200, at least one network switch receives a communication that is to be distributed utilizing a link aggregation bond coupling the at least one network switch to a multi-host link aggregation bond associated with a plurality of host devices sharing a common network address. The common network address may be an IP address.

In step 202, a determination is made as to whether the communication belongs to a session initiated by any of the plurality of host devices that are part of the multi-host link aggregation bond, utilizing a session store maintained by the at least one network switch.

In step 204, responsive to determining that the communication belongs to a session initiated by a given one of the plurality of host devices that is part of the multi-host link aggregation bond, a port number associated with the given host device is retrieved from the session store and the communication is distributed to the given host device utilizing the retrieved port number.

In step 206, responsive to determining that the communication does not belong to a session initiated by any of the plurality of host devices that are part of the multi-host link aggregation bond, one of the plurality of host devices is selected in accordance with a distribution algorithm and the communication is directed to the selected one of the plurality of host devices. The distribution algorithm may comprise a load balancing distribution algorithm. The plurality of host devices which are part of the multi-host link aggregation bond may provide an active-active cluster utilizing Link Aggregation Control Protocol (LACP) bond frame distribution for performing load balancing among the plurality of host devices.

The plurality of host devices may be part of a clustered system, and the session initiated by the given one of the plurality of host devices is utilized for communications initiated by the given one of the plurality of host devices to one or more external servers outside the clustered system. The one or more external servers may comprise at least one of a network time server, an authentication server, and an authorization server.

The FIG. 2 process may further include receiving, by the network switch, an additional communication from one of the plurality of host devices that is part of the multi-host link aggregation bond, determine whether the additional communication belongs to a session initiated by said one of the plurality of host devices that is part of the multi-host link aggregation bond and, responsive to determining that the additional communication belongs to the session initiated by said one of the plurality of host devices that is part of the multi-host link aggregation bond, updating an entry in the session store maintained by the at least one network switch for the session initiated by said one of the plurality of host devices that is part of the multi-host link aggregation bond. Updating the entry in the session store comprises updating session timeout information for the session initiated by said one of the plurality of host devices that is part of the multi-host link aggregation bond. Entries in the session store may be organized in B-tree forest and doubly linked list, and updating session timeout information for the session initiated by said one of the plurality of host devices that is part of the multi-host link aggregation bond may include moving the entry to a head of the doubly linked list.

The session store maintained by the at least one network switch may comprise a data structure with entries corresponding to sessions initiated by ones of the plurality of host devices that are part of the multi-host link aggregation bond. Each of the entries in the data structure may be associated with a session identifier for one of the sessions initiated by one of the plurality of host devices that are part of the multi-host link aggregation bond and specify a host-specific port for that session. Each of at least a subset of the plurality of host devices may be associated with a unique port range comprising ports available for use in sessions initiated by that host device. The FIG. 2 process may further include removing one or more entries from the data structure corresponding to sessions initiated by ones of the plurality of host devices that are part of the multi-host link aggregation bond which have timed out. Entries in the session store may be organized in a B-tree forest and doubly linked list with nodes sorted by timestamp of most recent activity, and removing the one or more entries from the data structure corresponding to sessions initiated by ones of the plurality of host devices that are part of the multi-host link aggregation bond which have timed out may include parsing the data structure beginning with a tail node of the doubly linked list having a least recent timestamp.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. It should further be appreciated that “generating” a data structure may encompass, for example, populating a previously-created data structure.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

The client/server model is a fundamental architecture used in computing and networking, where two programs or machines interact over a network. In this model, server load balancing and high availability are crucial components of modern IT infrastructure and application deployment. With the evolution of data center and edge network architectures, including scale-out clusters with highly distributed clients (e.g., Internet, IoT, etc.), there is a demand for a more effective and efficient solution for load balancing and high availability.

Linux Virtual Server (LVS) provides a powerful load balancing solution that may be used for distributing incoming traffic across a cluster of servers. LVS plays a critical role in the landscape of load balancing and high availability. Key components of an LVS solution include: an LVS director, which may be the load balancer itself, that is responsible for receiving incoming requests and forwarding them to the appropriate “real” server based on configured load balancing algorithms; real servers, back-end network and shared storage providing services to clients; and virtual IP (VIP), where the LVS director has a VIP address that clients use to access the services (e.g., with unicast). The LVS director forwards incoming traffic to the real servers based on the load balancing policy.

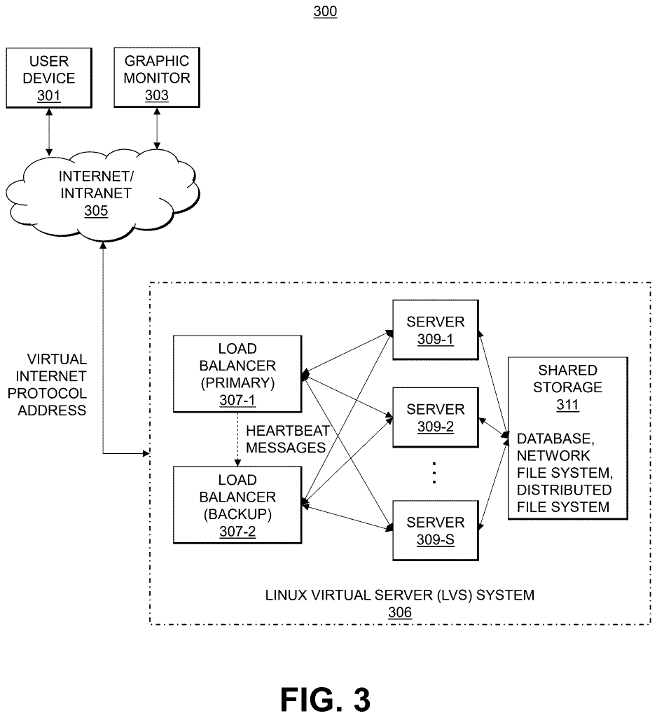

FIG. 3 shows a system 300 implementing an LVS solution, including a user device 301 and a graphic monitor 303 which are coupled via internet/intranet 305 using a VIP address to LVS system 306. The LVS system 306 includes a set of load balancers 307-1 and 307-2 (collectively, load balancers 307) providing the LVS director, a set of “real” servers 309-1, 309-2, . . . 309-S (collectively, servers 309), and shared storage 311. In the system 300, the load balancers 307 work in an active/standby mode, where the load balancer 307-1 is the primary load balancer and the load balancer 307-2 is the backup load balancer. The load balancer 307-1 provides periodic “heartbeat” messages to the load balancer 307-2. If the load balancer 307-2 does not receive a heartbeat message from the load balancer 307-1 in some configurable threshold amount of time, it will take over and act as the primary load balancer. In the system 300, clients (e.g., the user device 301 and graphic monitor 303) communicate with the load balancers 307 with a unicast mode, and the load balancers 307 distribute the requests to the servers 309 as per some configurable load balancing policy.

From the network communication paradigm, there is another totally different solution for cluster load balancing and high availability. Networks such as the Internet may support multiple communication paradigms, including: unicast, multicast/broadcast, and Anycast. Unicast is the point-to-point flow of packets between a single source (e.g., a client) and a destination (e.g., a server). LVS is an example of a unicast application. Multicast/broadcast is the point-to-multipoint flow of packets between a single source (e.g., a client) and one or more destinations (e.g., servers). Broadcast-style videoconferencing, for example, may employ IP multicast. Anycast is the point-to-point flow of packets between a single source (e.g., a client) and the “nearest” destination (e.g., server) in a cluster. The idea behind Anycast is that a client wants to send packets to any one of several possible servers offering a particular service or application, but does not care which specific one is used.

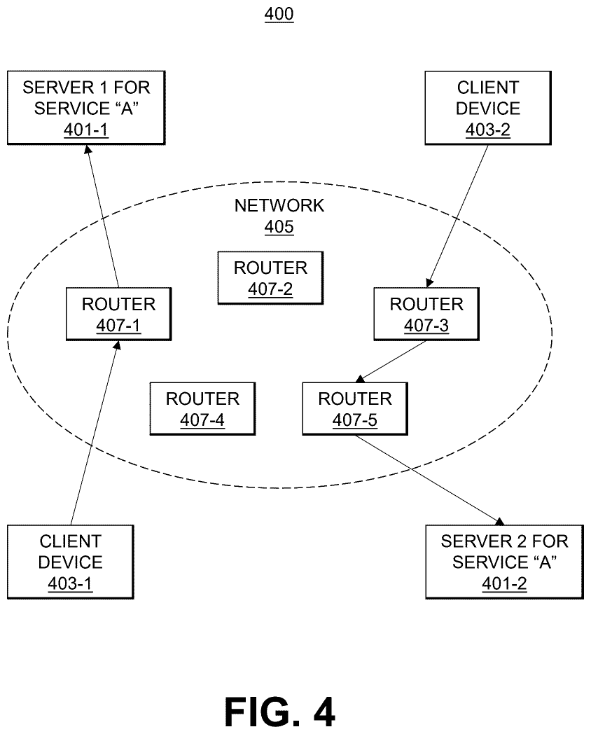

Anycast is a network addressing and routing method in which the same IP address (e.g., like the VIP address in LVS) is assigned to multiple servers or nodes. This technique may be used to improve the efficiency of Content Delivery Networks (CDNs), Domain Name Service (DNS), and other services. Multiple servers on the same Local Area Network (LAN) can be configured with the same anycast IP address. When packets are sent to the anycast IP address, routing protocols such as Border Gateway Protocol (BGP) will direct the traffic to the “closest” server based on the network's topology. Compared with the LVS solution, the requests are routed/distributed by routers or other network devices, without the need to introduce dedicated load balancers. FIG. 4 shows a system 400 implementing IP Anycast. The system 400 includes multiple servers 401-1 and 401-2 (collectively, servers 401) providing the same service “A”, and multiple client devices 403-1 and 403-2 (collectively, client devices 403) which access the service A. The client devices 403 and servers 401 communicate via network 405 comprising a set of routers 407-1, 407-2, 407-3, 407-4 and 407-5 (collectively, routers 407). In the example of FIG. 4, the client device 403-1 accesses server 401-1 (e.g., its “closest” one of the servers 401) via router 407-1. The client device 403-2 accesses server 401-2 (e.g., its “closest” one of the servers 401) via routers 407-3 and 407-5.

IP Anycast is not widely deployed in the Internet today. While Anycast provides several advantages for network routing and service delivery, it also has limitations that network designers and operators need to consider. Such limitations include routing complexity and consistency and session management. With regard to routing complexity, Anycast can complicate the routing configuration. Properly setting up and managing Anycast requires a good understanding of the routing protocols and mechanisms in use (e.g., BGP). The routing balance is not always uniform, which can lead to uneven traffic distribution across servers. With regard to consistency and session management, Anycast does not guarantee that all packets from a single connection will take the same path. If a client connects to one Anycast node and is then routed to another due to changes in the network, this can disrupt ongoing sessions or lead to inconsistent user experiences. Further, protocols requiring session persistence may encounter issues, as sessions might switch nodes unexpectedly.

In some implementations, IP Anycast relies on Layer 3 (L3) routing to distribute requests to the “nearest” server. In other implementations, an approach referred to as “Multi-Host Link Aggregation” is used, which utilizes Layer 2 (L2) link aggregation to distribute requests to any server in a cluster. This enables implementation of IP Anycast in a LAN based on link aggregation bonds (instead of routing), but has the drawback of not supporting conversations initiated from cluster nodes to external servers. Multi-Host Link Aggregation can handle client-initiated communications (e.g., also referred to as client-initiated conversations), but cannot guarantee that server-initiated communications (e.g., also referred to as server-initiated or cluster-initiated conversations) are established and maintained correctly. Thus, Multi-Host Link Aggregation is applicable for cluster systems which will not initiate conversations to external servers. For sophisticated cluster systems, however, it is critical to support both client-initiated and server-initiated conversations. Client-initiated conversations include, for example, IO operation requests from the client side (e.g., Internet Small Computer Systems Interface (iSCSI), Non-Volatile Memory Express (NVMe) over Transport Control Protocol (TCP) (NVMe-over-TCP), NFS, SMB, object storage, etc.). Server-initiated conversations include, for example, requests from nodes in the cluster to external servers (e.g., authorization/authentication requests like Active Directory (AD), Lightweight Directory Access Protocol (LDAP), Kerberos, etc.).

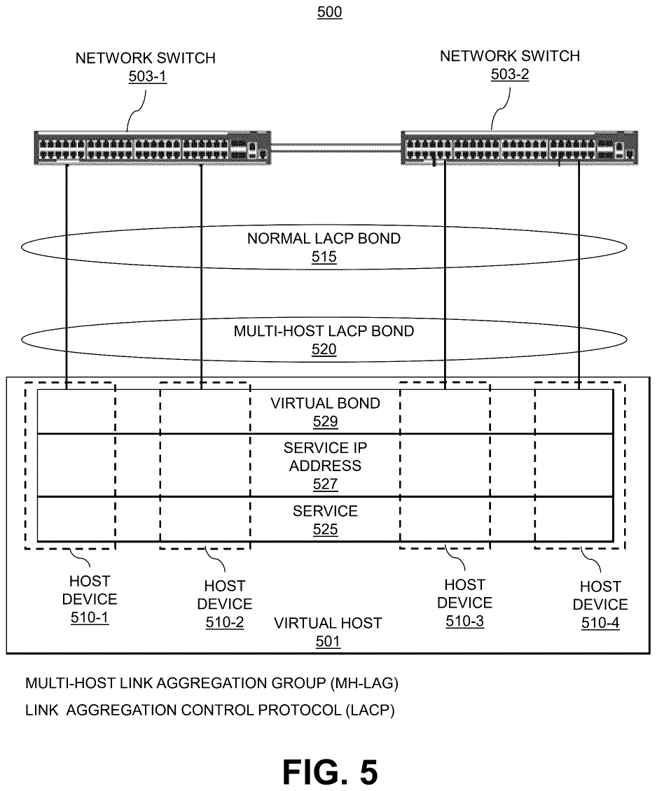

FIG. 5 shows a system 500 implementing the Multi-Host Link Aggregation approach. The system 500 includes a cluster shown as a virtual host 501 with a plurality of host devices 510-1, 510-2, 510-3 and 510-4 (collectively, host devices 510) shown in dashed outline. Although not shown, each of the host devices 510 is assumed to implement a Multi-Host Link Aggregation Group (MH-LAG) agent, which is responsible for managing (e.g., creating, modifying, deleting, etc.) MH-LAGs of the cluster, for sending requests (e.g., Link Aggregation Control Protocol Data Units (LACPDUs)) to peers, for syncing Address Resolution Protocol (ARP) caches with all involved hosts, etc. The MH-LAG agents communicate with each other via a management network. The host devices 510 are in communication with network switches 503-1 and 503-2 (collectively, network switches 503). The Multi-Host Link Aggregation approach builds a multi-host LACP bond 520 for the host devices 510. The multi-host LACP bond 520 is viewed as a normal LACP bond 515 by peer ports on the network switches 503. The host devices 510 are assumed to implement a service 525 associated with a service IP address 527 that is shared across the host devices 510, and thus provides a virtual bond 529.

To summarize the Multi-Host Link Aggregation approach, the cluster may be taken or considered as a large virtual host (e.g., the virtual host 501 in system 500), with a virtual LACP bond (e.g., the multi-host LACP bond 520 in system 500) being configured on this virtual host. Agents (e.g. MH-LAG agents) running on each “real” host (e.g., host devices 510 in system 500) coordinate the creation of the virtual or multi-host LACP bond and make it look like a real or normal LACP bond (e.g., normal LACP bond 515 in system 500) by its adjacent network switches (e.g., network switches 503 in system 500) by advertising fake LACPDUs. A VIP address (e.g., service IP address 527 in system 500) is configured on all the real hosts in the cluster, and the agents will synch among all the real hosts with an ARP cache.

One of the keys to the Multi-Host Link Aggregation approach is, according to Institute of Electrical and Electronics Engineers (IEEE) standards (e.g., 802.3ad and 802.1AX standards), the Frame Distributor ensuring that all frames of a given conversation are passed to a single port to avoid mis-order or duplicate transmission. For client-initiated sessions, an IEEE standard-compatible network switch should always distribute the successive frames of a conversation to the same link, so that the same host, client-initiated conversations work perfectly fine. The network switch, however, cannot guarantee distribution of successive packets of a cluster-initiated conversation to the aggregation port where it is received and thus cluster-initiated conversations might fail. Although in the client/server model, servers normally do not initiate conversations to client hosts, in various situations the servers need to work as a client to visit or utilize external services like LDAP, Kerberos, etc. Thus, technical solutions are needed to handle conversations initiated from the cluster.

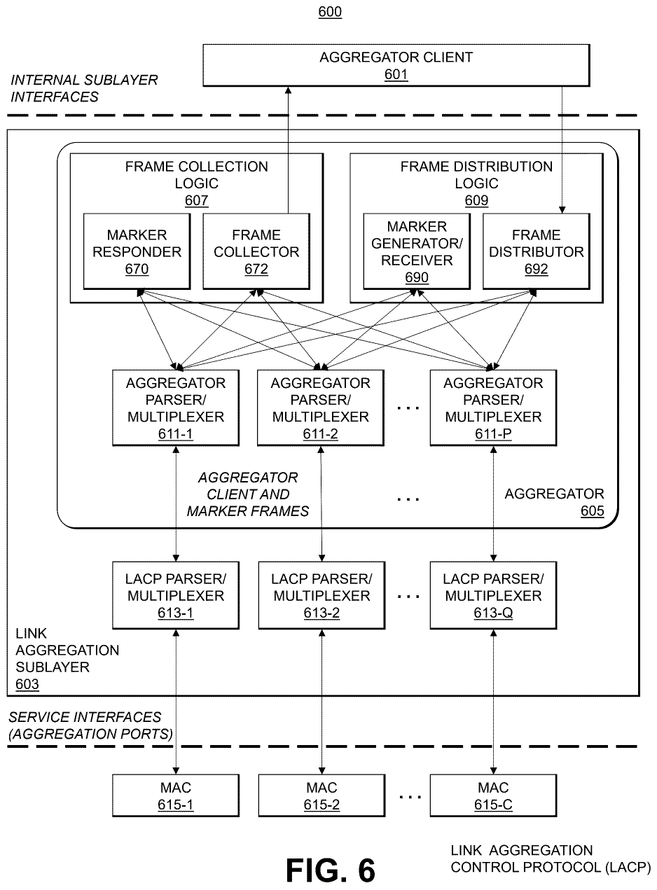

To resolve the cluster-initiated conversation problem, network switch link aggregation frame distribution algorithms need to identify if the frame to be distributed belongs to a client-initiated conversation or a cluster-initiated conversation. FIG. 6 shows a system 600 for implementing an aggregator client 601 and a link aggregation sublayer 603 (e.g., in accordance with IEEE standard 802.1AX-2020). The aggregator client 601 and link aggregation sublayer 603 communicate over internal sublayer interfaces. The link aggregation sublayer 603 implements an aggregator 605 comprising frame collection logic 607 and frame distribution logic 609. The frame collection logic 607 implements a marker responder 670 and a frame collector 672, while the frame distribution logic 609 implements a marker generator/receiver 690 and frame distributor 692 implementing frame distribution algorithms. The aggregator 605 further comprises a set of aggregator parsers/multiplexers 611-1, 611-2, . . . 611-P (collectively, aggregator parsers/multiplexers 611), which communicate marker frames (e.g., to/from marker responder 670 and/or marker generator/receiver 690), and aggregator client frames (e.g., to/from frame collector 672 and/or frame distributor 692). The link aggregation sublayer 603 further comprises LACP parsers/multiplexers 613-1, 613-2, . . . 613-Q (collectively, LACP parsers/multiplexers 613), which communicate the marker and aggregator client frames to and from service interfaces providing media access control (MAC) aggregation ports 615-1, 615-2, . . . 615-C (collectively, MAC aggregation ports 615).

The frame distribution algorithm may utilize VLAN tags to address the cluster-initiated conversation problem, where if one of the nodes in a cluster needs to initiate a conversation to an external server, service software chooses a separate logic port (e.g., associated with a VLAN tag). Since there are different VLAN tags for different nodes in the cluster, the distribution algorithm is able to support cluster-initiated conversations.

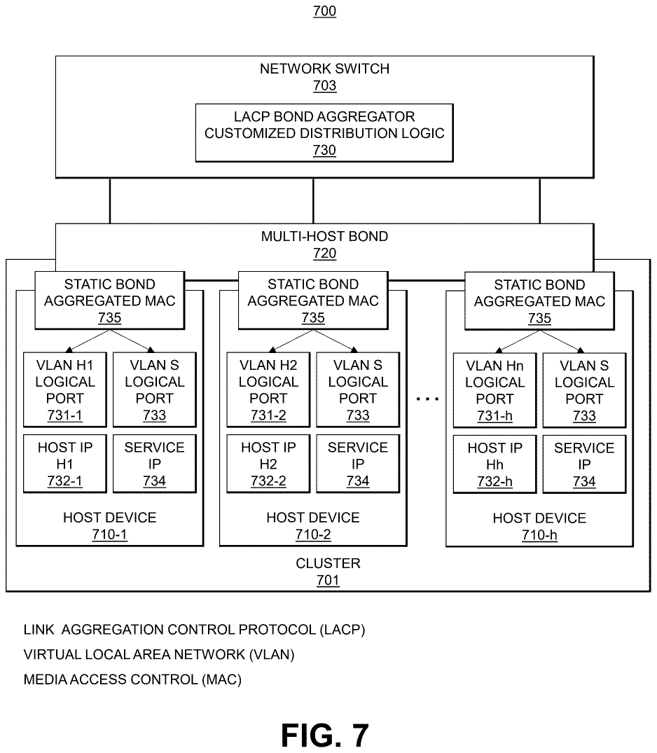

FIG. 7 shows a system 700 implementing the Multi-Host Link aggregation approach with VLAN tags. The system 700 includes a cluster 701 comprising a plurality of host devices 710-1, 710-2, . . . 710-h (collectively, host devices 710). Although not shown, each of the host devices 710 is assumed to implement a MH-LAG agent as described above. The host devices 710 are in communication with a network switch 703. The Multi-Host Link Aggregation approach builds a multi-host bond 720 (e.g., a multi-host LACP bond) for the host devices 710. The multi-host bond 720 is viewed as a normal LACP bond by peer ports on the network switch 703. Each of the host devices 710-1, 710-2, . . . 710-h is associated with a host IP address H1 732-1, H2 732-2, . . . Hh 732-h (collectively, host IP addresses 732) and a service IP address 734. The host devices 710-1, 710-2, . . . 710-h also create respective VLAN logical devices associated with VLAN H1 logical port 731-1, VLAN H2 logical port 731-2,. VLAN Hh logical port 731-h (collectively, VLAN host logical ports 731) and a VLAN service(S) logical port 733.

The VLAN logical devices are associated with a static bond device on each of the host devices 710, shown as static bond aggregated MAC 735. Each of the static bond devices is associated with a unique VLAN host logical port (e.g., one of the VLAN host logical ports 731) and a same VLAN service logical port (e.g., VLAN S logical port 733). The VLAN host logical ports 731 are associated with host VLAN tags (VLAN_H1, VLAN_H2, . . . VLAN_Hh) which are different for each of the host devices 710 in the cluster 701, and which are used for server-initiated or cluster-initiated conversations. The VLAN S logical port 733 is for a service VLAN device used for client-initiated conversations, and has the same service VLAN tag (VLAN_S) for all of the host devices 710 in the cluster 701. The host devices 710 are configured with different host IP addresses 732 (e.g., IP_H1, IP_H2, . . . IP_Hh), with the host IP addresses 732 being configured on the host VLAN logical devices. The host IP addresses 732 are planned for use in server-initiated or cluster-initiated conversations only (e.g., communications initiated by the host devices 710). The host devices 710 are also each configured with the same service IP address 734. The service IP address 734 is configured for the service VLAN logical device. The service IP address 734 is planned for use in client-initiated conversations only. The network switch 703 implements LACP bond aggregator customized distribution logic 730, which is configured to handle distribution of communications for both client-initiated conversations and server-initiated or cluster-initiated conversations utilizing a customized and standard-compliant (e.g., IEEE 802.3ad or IEEE 802.1AX) distribution algorithm.

The VLAN tag approach illustrated in FIG. 7, however, impacts cluster service implementation, network switch LACP implementation, and may require complex manual configuration on both cluster nodes and adjacent network switches. The cluster service software must be aware of this solution, and choose a proper interface for cluster-initiated conversations. Each node must be configured with a dedicated host IP and a dedicated VLAN, which is a complex and wired configuration. Further, a static configuration on the network switch LACP is needed, to map VLAN tags with aggregation ports. This is prone to misconfiguration, if the VLAN tags configured on hosts are mismatched with the mapping of VLAN tags and aggregation ports.

Illustrative embodiments provide technical solutions that support both client-initiated server-initiated or cluster-initiated conversations with a self-learning, high performance configuration on the network switch, with such functionality being referred to herein as “LACP+” functionality. Advantageously, the technical solutions in some embodiments have no impact on the cluster service, do not require extra network configuration on the cluster, and do not require static or manual configuration on the network switch LACP. The network switch instead is able to distinguish between client initiated and cluster-initiated sessions by self-learning. Further, the technical solutions in some embodiments have no obvious or significant impact on IOPS, bandwidth and network switch distribution performance. The technical solutions in some embodiments provide an approach for implementing IP Anycast in the front end of a cluster, which can support both client-initiated and cluster-initiated sessions.

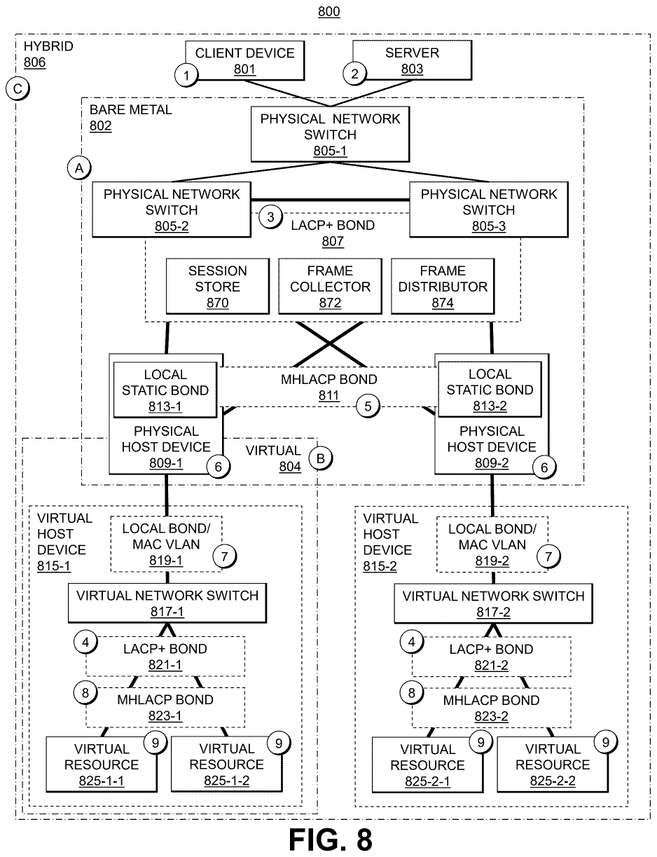

FIG. 8 shows a system 800 configured for supporting both client-initiated and cluster-initiated conversations. The system 800 includes client device 801, an “external” server 803, physical network switches 805-1, 805-2 and 805-3 (collectively, physical network switches 805), and physical host devices 809-1 and 809-2 (collectively, physical host devices 809). The physical host device 809-1 implements a virtual host device 815-1 comprising a virtual network switch 817-1 and virtual resources 825-1-1 and 825-1-2 (collectively, virtual resources 825-1). The physical host device 809-2 implements a virtual host device 815-2 comprising a virtual network switch 817-2 and virtual resources 825-2-1 and 825-2-2 (collectively, virtual resources 825-2). The virtual host devices 815-1 and 815-2 are collectively referred to as virtual host devices 815, the virtual network switches 817-1 and 817-2 are collectively referred to as virtual network switches 817, and the virtual resources 825-1 and 825-2 are collectively referred to as virtual resources 825. The virtual resources 825 may comprise VMs, containers, etc., possibly with a common namespace.

The system 800 is configured for the following:
1. The client device 801 requests services provided by a cluster of nodes (e.g., the physical host devices 809 and/or the virtual host devices 815). In the client/server model, the client device 801 acts as the “client” which initiates sessions to the “server” (e.g., the physical host devices 809 and/or the virtual host devices 815) to request services or resources.
2. The server 803 is external to the cluster of nodes (e.g., the physical host devices 809 and/or the virtual host devices 815), and thus may be referred to as an external server. The server 803 may provide various services (e.g., LDAP, Kerberos, Key Management Interoperability Protocol (KMIP), etc.) that may be consumed by the cluster of nodes. In some cases, nodes in the cluster (e.g., the physical host devices 809 and/or the virtual host devices 815) initiate conversations with the server 803 to consume such services. In such cases, the nodes in the cluster take on the “client” role in the client/server model.
3. The physical network switches 805-2 and 805-3 support and implement LACP+ bond 807.
4. The virtual network switch 817-1 supports and implements LACP+ bond 821-1 and the virtual network switch 817-2 supports and implements LACP+ bond 821-2. The LACP+ bonds 821-1 and 821-2 are collectively referred to as LACP+ bonds 821.

Link aggregation on the physical network switches 805 and the virtual network switches 817 may follow vendor-independent standards, such as the LACP for ethernet defined in the IEEE 802.1AX and 802.3ad standards. The technical solutions described herein provide an approach referred to as LACP+, which is compatible with these and other standards and provides enhancements for frame distribution. The LACP+ functionality (e.g., implemented using LACP+ bond 807 and LACP+ bonds 821) is able to distinguish between conversations initiated from its adjacent aggregation port or other ports. If frames belong to conversations initiated from an adjacent aggregation port, the LACP+ functionality will distribute the frames to the aggregation port from which the previous frame of the same conversation was received.

As shown in FIG. 8, the LACP+ bond 807 comprises a session store 870, a frame collector 872, and a frame distributor 874. The frame collector 872 is enhanced with functionality to check if a received frame from a peer (e.g., MHLACP) belongs to a cluster-initiated conversation. If the frame belongs to a cluster-initiated conversation, the frame collector 872 will maintain the session identifier (ID) and port ID (e.g., from which the frame is received) for tracking in the session store 870. The frame distributor 874 is enhanced with functionality for checking if frames to be distributed belongs to a cluster-initiated conversation. If not, the frame distributor 874 will distribute the frame using any suitable algorithm (e.g., an IEEE standard compliant algorithm, such as an L2 or L3 hash algorithm). If the frame to be distributed belongs to a cluster-initiated session, the frame distributor 874 will retrieve the port number or port ID from the session store 870 using the session ID, and will distribute the frame to that port. The LACP+ bond 807 thus provides novel functionality in the frame collector 872 and frame distributor 874 for judging the initiator of a conversation using a single frame or packet, and for maintaining the session store 870 to provide a database for managing cluster-initiated conversation creation, query, deletion, and timeout with acceptable performance.
5. The physical host devices 809 implement MHLACP bond 811
6. After the MHLACP bond 811 is created, a service VIP address is configured on the physical host devices 809 created by the LACP agent, and a cluster service is launched to bind its service to the VIP address on each node.
7. The virtual network switches 817-1 and 817-2 implement local bond/MAC VLAN 819-1 and 819-2 (collectively, local bonds/MAC VLANs 819), which provide uplink of the virtual network switches 817 (e.g., bridges in Linux network virtualization), where the local bonds/MAC VLANs 819 provide the logical network device created by the agents (e.g., the MHLACP agents) on the physical host devices 809.
8. The virtual host devices 815-1 and 815-2 implement respective MHLACP bonds 823-1 and 823-2 (collectively, MHLACP bonds 823).
9. After the MHLACP bonds 823 are created, a service VIP address is configured on the virtual host devices 815 created by the LACP agent, and a cluster service is launched to bind its service to the VIP address on each node.

The MHLACP bond 811 and MHLACP bonds 823 are created relying on agents running on the nodes in the cluster (e.g., the physical host devices 809 and/or the virtual resources 825 implemented on the virtual host devices 815). After all logical devices are created, a primary agent would advertise LACPDUs to adjacent ones of the network switches (e.g., ones of the physical network switches 805 and/or the virtual network switches 817). The LACP bonds on the network switch side and the cluster side will be in collecting and distributing states after the exchange of the LACPDUs. The agents will keep advertising the LACPDUs to keep the LACP states and synchronize ARP neighbors among all nodes in the cluster. MHLACP could be deployed within the virtualization mode as well.

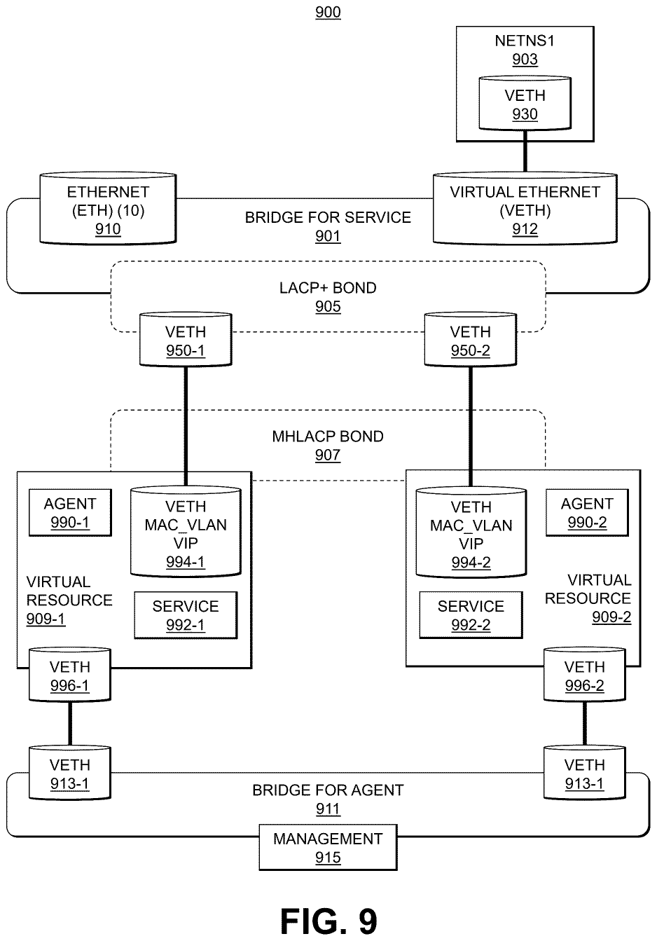

FIG. 9 shows a system 900 implementing MHLACP in a virtualization environment in a Linux network namespace (NetNS) with Docker containers or other virtual resources. The system 900 includes a bridge for service 901 and NETNS1 903. The bridge for service 901 implements ethernet (ETH) 10 910 and virtual ethernet (VETH) 912. The bridge for service 901 communicates with NETNS1 903 utilizing VETH 912 and VETH 930. The bridge for service 901 also implements LACP+ bond 905 having VETH 950-1 and 950-2 (collectively, VETHs 950), configured for communication with virtual resources 909-1 and 909-2 (collectively, virtual resources 909) utilizing MHLACP bond 907. The virtual resource 909-1 implements agent 990-1, service 992-1, VETH MAC_VLAN VIP 994-1 and VETH 996-1, and the virtual resource 909-2 implements agent 990-2, service 992-2, VETH MAC_VLAN VIP 994-2 and VETH 996-2. The agents 990-1 and 990-2 are collectively referred to as agents 990, the services 992-1 and 992-2 are collectively referred to as services 992, the VETH MAC_VLAN VIPs 994-1 and 994-2 are collectively referred to as VETH MAC_VLAN VIPs 994, and the VETHs 996-1 and 996-2 are collectively referred to as VETHs 996. The system 900 also includes a bridge for agent 911 implementing VETH 913-1 and VETH 913-2 (collectively, VETHs 913) configured for communication with virtual resources 909 utilizing VETHs 996. The bridge for agent 911 also implement management functionality 915.

Referring back to FIG. 8, the system 800 may deploy cluster services in different modes, including a bare metal mode 802 (mode A), a virtual mode 804 (mode B), and a hybrid mode 806 (mode C). In the bare metal mode 802 and virtual mode 804, there is no difference in the responsibilities of the components in LACP+ described above. Although not shown for clarity of illustration, in the virtual mode 804 each of the LACP+ bonds may implement a session store, a frame collector and a frame distributor with functionality similar to that of the session store 870, the frame collector 872 and the frame distributor 874, respectively. In the hybrid mode 806, the responsibilities of components in the bare metal and virtual levels are different to avoid duplicate calculations.

In the hybrid mode 806, there are two levels of switches (e.g., the physical network switches 805 and the virtual network switches 817). While it is possible to duplicate all of the LACP+ functionality on both levels, this may have some negative impacts on performance (e.g., resulting from keeping the whole data structure and compute/query algorithms on both levels). With use of a tagging strategy, the responsibility of components of LACP+ will differ for each level. At the virtual network switch level, the LACP+ bonds 821 implement frame collectors which are responsible for checking if the received communication (e.g., a packet or frame) from a peer (e.g., MHLACP bonds 823) belongs to cluster-initiated conversations. If a frame belongs to a cluster-initiated conversation, the frame collector will tag that frame with aggregation port information as will be described in further detail below. At the virtual network switch level, the LACP+ bonds 821 also implement frame distributors which are responsible for retrieving tags from the frames to be distributed, removing the tags from the frames, and distributing the frames to the aggregation port indicated by the tags. If no tag is detected for a frame, that frame will be distributed using any desired frame distribution algorithm (e.g., an IEEE standard-compliant frame distribution algorithm). At the physical network switch level, the frame collector 872 is responsible for checking if a received frame or packet from a peer belongs to a cluster-initiated conversation. If the received frame or packet belongs to a cluster-initiated conversation, the frame collector 872 will store a conversation attribute as a key in the session store 870, with the associated value being a tag and a physical network switch aggregation port. The frame distributor 874 is responsible for checking if a frame/packet to be distributed belongs to a cluster-initiated session, which should already be stored in the session store 870. If not, the frame distributor 874 will distribute the frame/packet using any desired frame distribution algorithm (e.g., an IEEE standard-compliant frame distribution algorithm, such as an L2 or L3 hash algorithm). If the frame/packet belongs to a session stored in the session store 870, its tag and aggregation port are retrieved from the session store 870, and the frame is tagged accordingly and distributed to the retrieved aggregation port. Thus, in the hybrid mode 806, the session store 870 actively works in the physical network switch level.

In a majority of use case scenarios, the concurrent number of client-initiated conversations or sessions may vary (e.g., from just a few to potentially thousands or tens of thousands). The concurrent number of cluster-initiated conversations or sessions, however, is expected to be limited (e.g., typically, tens of conversations or sessions). Multiple cluster nodes may initiate conversations to the same external server simultaneously. Cluster nodes share the same VIP address, and the destination IP address and destination port will be the same (e.g., for conversations with the same external server). If sessions on different cluster nodes happen to choose the same source port number, there would be no way to discriminate sessions originating at or from different ones of the cluster nodes. Although the possibility of choosing the same source port is expected to be rare, the technical solutions in some embodiments implement a mechanism which utilizes MHLACP agents to set a local port range (local_port_range) on each cluster node to avoid overlapping of port ranges preventing multiple cluster nodes from choosing the same source port for cluster-initiated conversations. With this approach, conversations or sessions initiated from the cluster by different nodes thereof can be distinguished by their respective combinations of a destination IP address, a destination port and a source port.

Internet Engineering Task Force (IETF) Request for Comments (RFC) 6335 section 6 defines port number ranges as: system ports, also known as “well known” ports, from 0-1023, assigned by the Internet Assigned Numbers Authority (IANA); user ports, also known as “registered” ports, from 1024-49151, assigned by the IANA; and dynamic ports, also known as “private” or “ephemeral” ports, from 49152-65535, not assigned. The method for judging the initiator of a conversation or session utilizing a single frame/packet assumes that the cluster service should listen on a port in the range of system ports or user ports. When a cluster host initiates requests to external services, it will use a port in the range of the dynamic ports as the local port. No assumptions are made with respect to external clients or servers outside the cluster.

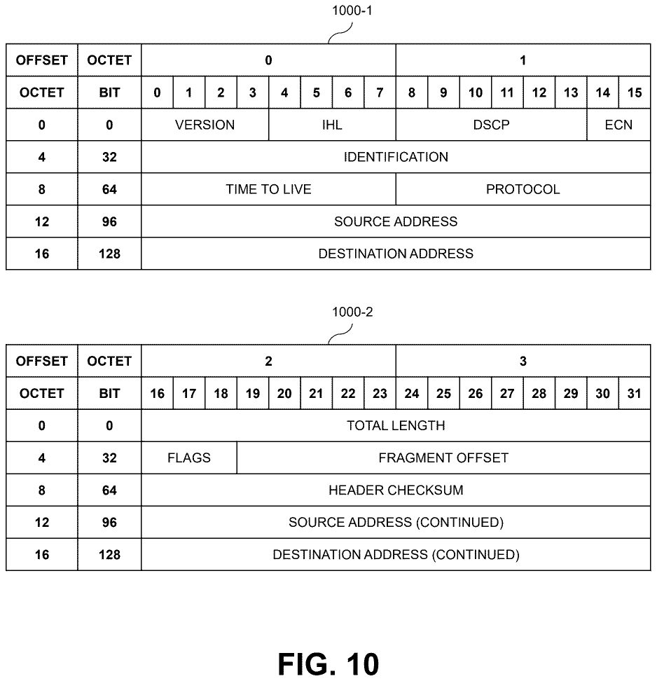

Referring back to FIG. 8, in the hybrid mode 806, a tag on an IP packet is used by the physical network switches 805 and/or the virtual network switches 817 to exchange an aggregation port number on the virtual network switches 817. In practice, the number of aggregation ports that can be added to one aggregating system is limited (e.g., to 8 or 16). Up to 6 bits should be enough for the tag. Conversations utilizing TCP are distinguished by LACP+. Since TCP fragments packets in the TCP level by a Maximum Segment Size (MSS), the fragment offset of TCP packets should always be zero, and the “fragment offset” can be used as the tag between the virtual network switches 817 and the physical network switches 805. FIG. 10 shows portions 1000-1 and 1000-2 of a header format (e.g., for IPv4), with the portions 1000-1 and 1000-2 being collectively referred to as header format 1000. As illustrated, the header format 1000 provides the fragment offset which in some embodiments is used for communicating tag information between the physical and virtual network switch level.

In the frame collector, for each received frame, if the source port is located in the range of dynamic ports, the frame is determined to be one which belongs to a cluster-initiated session or conversation. In the frame distributor, for each frame to be distributed, if the destination port is located in the range of dynamic ports, the frame is determined to be one that belongs to a cluster-initiated session or conversation. In some embodiments, the session store may maintain one or more data structures, such as a hash table, for lookup of session IDs. If the number of current cluster-initiated sessions or conversations is limited (e.g., less than a hundred) and the collision rate is low, the performance should be almost O(1).

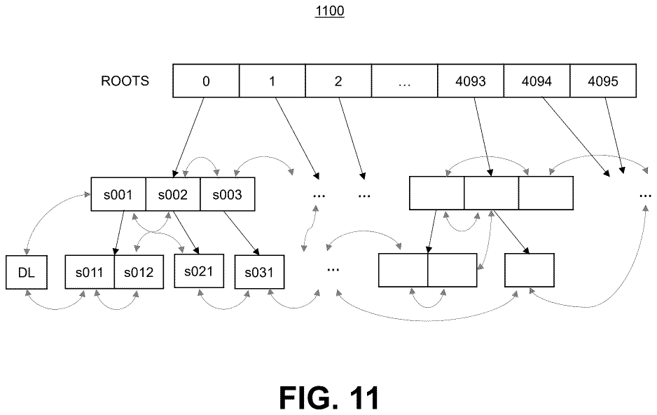

In other embodiments, other types of data structures and techniques may be used in implementing the session store (e.g., for when the number of possible cluster-initiated sessions or conversations is large). FIG. 11 shows an example data structure 1100 including a 4096 element B-Tree Forest combined with a doubly linked list. This specific design aims to enhance the efficiency and performance of session storage. As the session store keeps all active cluster-initiated sessions, the space consumed is O(n), were n is the maximum number of concurrent cluster-initiated sessions. The B-Tree provides good performance in data querying (e.g., determining whether a session exists or not) and updating (e.g., inserting and deleting). Both operations could be performed with O(log n) effort. Compared to other data set implementations, such as Bloom filters, B-Tree is accurate and has no false positive/negative results.

A forest implements a hash table. Based on the constraint that there are expected to only be hundreds of concurrent cluster-initiated sessions, most of the B-Trees will be empty. Thus, most query operations could be performed with O(1) effort (e.g., computing a hash code and checking if the related root pointer is null).

The number of elements used in the data structure 1100 (i.e., 4096) is selected for session or conversation IDs, as the session or conversation ID (e.g., a value in the range of 0-4095) is a hash code derived from L2/L3 session attributes. This can be reused to speed operations in the B-Tree Forest, such that there is no need to compute another hash code. The IEEE 802.1AX-2022 standard, for example, defines a conversation ID as an integer in the range of 0 through 4095, where each value identifies one or more conversations.

The doubly linked list implements a high-performing priority queue which is crucial for finding and removing timeout sessions. The doubly linked list allows quick insertion of an element at the head (e.g., O(1)) and removing a given element (e.g., given the pointer, also O(1)). In this list, nodes are sorted with the timestamp and the node with the latest timestamp is always the head. When a frame in a session is received, it will be queried-from or inserted-into the set. Either operation will locate the node in the set along the B-Tree (e.g., with effort O(log n)). Then the node will be updated with the current timestamp, and moved to the head of the list (e.g., with effort O(1)).

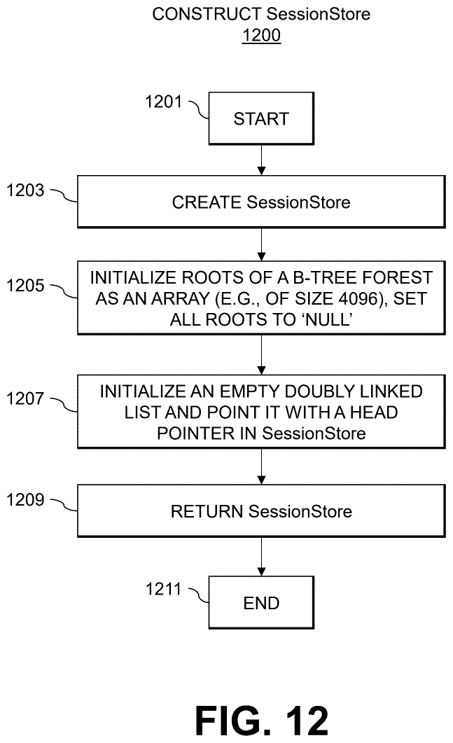

FIG. 12 shows a process flow 1200 for constructing a session store, denoted SessionStore. The process flow 1200 starts in block 1201 and in block 1203 a command is received to create the session store (SessionStore). In block 1205, roots of a B-Tree Forest are initialized as an array (e.g., of size 4096), and all roots are set to a null value (e.g., NULL). In block 1207, an empty doubly linked list is initialized, and is pointed with a head pointer in SessionStore. In block 1209, SessionStore is returned, and the process flow 1200 ends in block 1211.

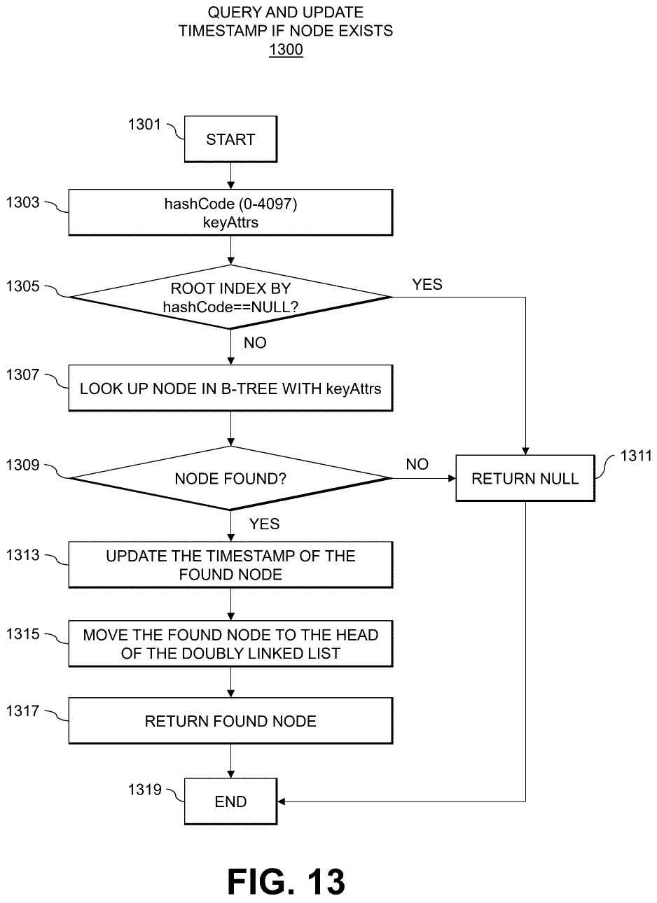

FIG. 13 shows a process flow 1300 for querying and updating the session store to determine if a session or conversation ID exists (e.g., with effort O(log n)). The process flow 1300 starts in block 1301, and hashCode (e.g., in the range 0-4097) and keyAttrs of a session or conversation are defined or received in block 1303. In block 1305, a determination is made as to whether the root index pointed to by hashCode is a null value. If the result of the block 1305 determination is no, the process flow 1300 proceeds with looking up the node in the B-Tree with keyAttrs in block 1307. In block 1309, a determination is made as to whether a node is found. If the result of the block 1309 determination is no, or if the result of the block 1305 determination is yes (e.g., which is the more common situation in cases where it is expected that there are relatively few cluster-initiated sessions), the process flow 1300 proceeds to block 1311 where a null value is returned. If the result of the block 1309 determination is yes, the timestamp of the found node is updated in block 1313. The found node is then moved to the head of the doubly linked list in block 1315, and the found node is returned in block 1317. Following block 1317 or block 1311, the process flow 1300 ends in block 1319.

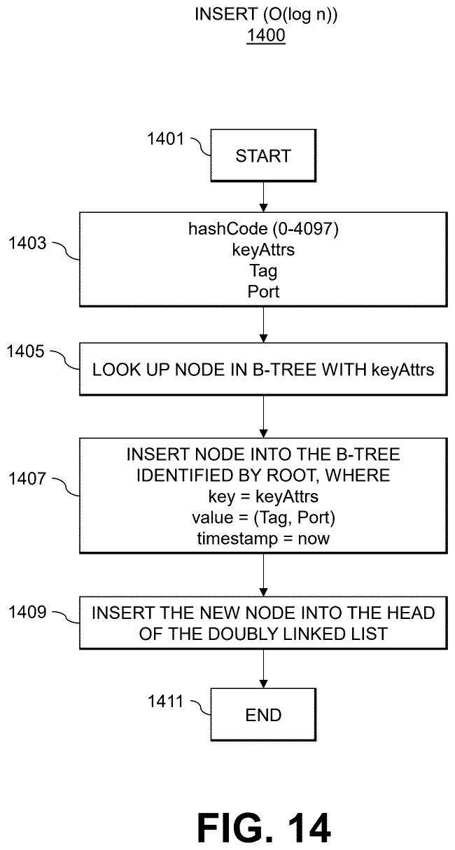

FIG. 14 shows a process flow 1400 for an insert operation (e.g., which has effort O(log n)). The process flow 1400 starts in block 1401, followed by defining or receiving hashCode, keyAttrs, Tag and Port for the session or conversation to be inserted in block 1403. In block 1405, a node in the B-tree is looked up using keyAttrs. In block 1407, the node is inserted into the B-Tree identified by the root, with key=keyAttrs, value=(Tag, Port), and timestamp=now. In block 1409, the new node is inserted into the head of the double linked list, and then the process flow 1400 ends in block 1411.

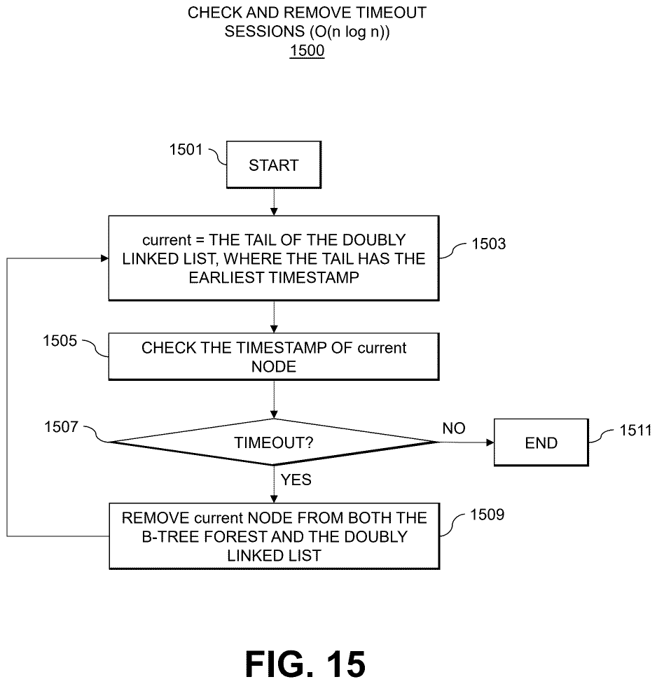

FIG. 15 shows a process flow 1500 for checking and removing timed-out sessions (e.g., which has effort O(n log n)). The process flow starts in block 1501, where the tail of the double linked list has the earliest timestamp. In block 1503, the value current is set to the node at the tail of the doubly linked list. In block 1505, the timestamp of the current node is checked. In block 1507, a determination is made as to whether the session associated with the current node has timed out. If the result of the block 1507 determination is yes, the current node is removed from both the B-Tree and the doubly linked list in block 1509, and the process flow 1500 returns to block 1503 to set another node as the new or updated current node (e.g., the new “tail” of the doubly linked list following removal of the previous current node). If the result of the block 1507 determination is no, the process flow 1500 ends in block 1511.

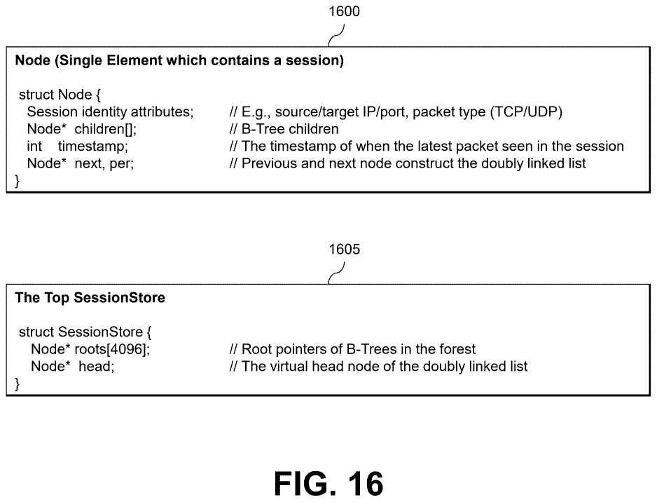

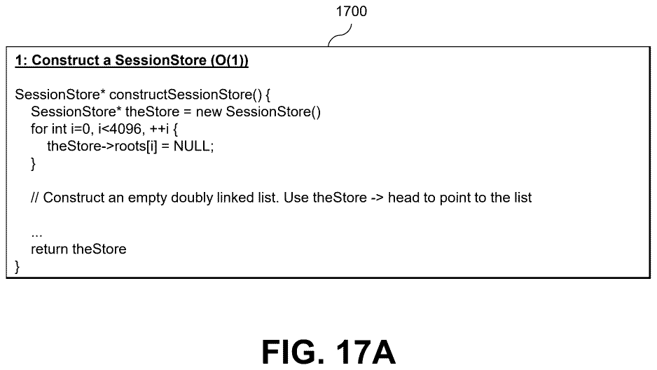

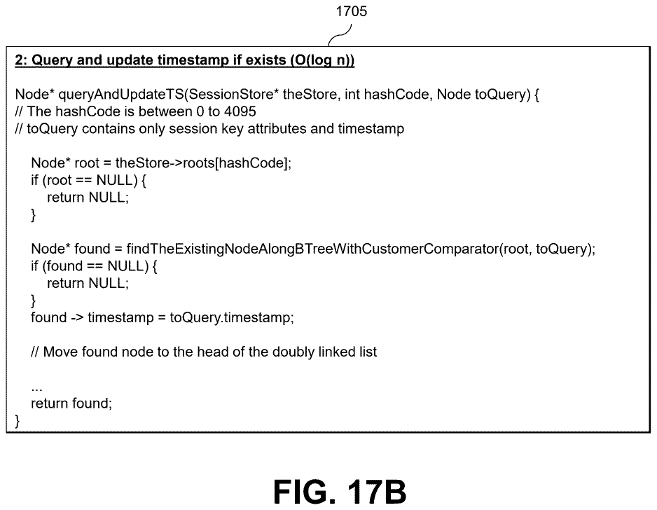

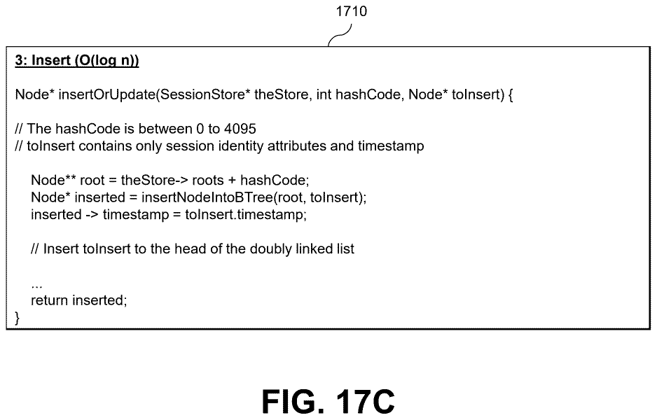

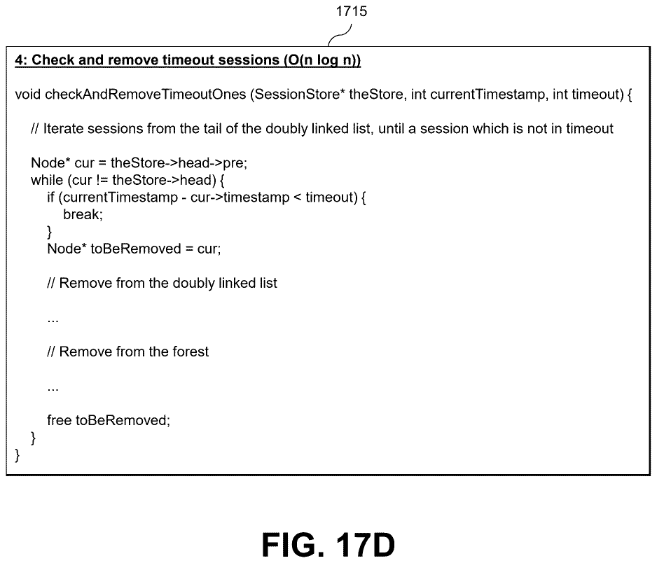

FIG. 16 shows pseudocode 1600 for generating or defining nodes (e.g., representing cluster-initiated sessions or conversations) and pseudocode 1605 for generating or defining the session store (SessionStore). FIG. 17A shows pseudocode 1700 which may be utilized to implement the process flow 1200 of FIG. 12 (e.g., to construct SessionStore). FIG. 17B shows pseudocode 1705 which may be utilized to implement the process flow 1300 of FIG. 13 (e.g., to query SessionStore and update a timestamp of a node, if it exists in SessionStore). FIG. 17C shows pseudocode 1710 which may be utilized to implement the process flow 1400 of FIG. 14 (e.g., to insert a node into SessionStore). FIG. 17D shows pseudocode 1715 which may be utilized to implement the process flow 1500 of FIG. 15 (e.g., to check and remove nodes corresponding to timed-out sessions).

The technical solutions described herein provide a novel approach which may be utilized for implementing Anycast to a cluster in LAN with load balancing based on L2 hashing. The technical solutions described herein provide support for both client-initiated and cluster-initiated conversations or sessions, and has no impact on performance for client-initiated conversations (e.g., which are expected to be the majority of traffic). For cluster-initiated conversations, if the number of concurrent cluster-initiated conversations is limited the time performance impact is O(1). If the number of concurrent cluster-initiated conversations is very large, the time performance impact is O(log n) and the space performance impact is O(n). Considering that n (e.g., the number of concurrent cluster-initiated sessions) is expected to be limited and is normally less than 100, both the time and space performance impact are minor.

The technical solutions described herein can advantageously be implemented with any existing cluster product, with suitable modifications to the service implementation as described herein. In the technical solutions described herein, cluster-initiated sessions are discriminated and managed in a session store, so different policies could be applied to frames that belong to cluster-initiated conversations. This is applicable for various use case scenarios, such as where cluster-initiated conversations belonging to different Quality of Service (QoS) levels can be handled differently based on fields in packet/frame headers to manage those conversations (e.g., in a high-performance session store). Frames belonging to different QoS streams could be distributed with different policies with limited performance impact.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for managing communications for sessions initiated by host devices which are part of a multi-host link aggregation group will now be described in greater detail with reference to FIGS. 18 and 19. Although described in the context of system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that may be utilized to implement at least a portion of the information processing system 100 in FIG. 1. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 1800 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 may comprise respective VMs, respective sets of one or more containers, or respective sets of one or more containers running in VMs.

In some implementations of the FIG. 18 embodiment, the VMs/container sets 1802 comprise respective VMs implemented using virtualization infrastructure 1804 that comprises at least one hypervisor. A hypervisor platform may be used to implement a hypervisor within the virtualization infrastructure 1804, where the hypervisor platform has an associated virtual infrastructure management system. The underlying physical machines may comprise one or more distributed processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of system 100 and includes a plurality of processing devices, denoted 1902-1, 1902-2, 1902-3, . . . 1902-K, which communicate with one another over a network 1904.

The network 1904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1902-1 in the processing platform 1900 comprises a processor 1910 coupled to a memory 1912.

The processor 1910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1912 may comprise random access memory (RAM), read-only memory (ROM), flash memory or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for managing communications for sessions initiated by host devices which are part of a multi-host link aggregation group as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, clustered systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to receive, by at least one network switch, a communication to be distributed utilizing a link aggregation bond coupling the at least one network switch to a multi-host link aggregation bond associated with a plurality of host devices sharing a common network address;
to determine, utilizing a session store maintained by the at least one network switch, whether the communication belongs to a session initiated by any of the plurality of host devices that are part of the multi-host link aggregation bond;
responsive to determining that the communication belongs to a session initiated by a given one of the plurality of host devices that is part of the multi-host link aggregation bond, to retrieve a port number associated with the given host device from the session store and to distribute the communication to the given host device utilizing the retrieved port number; and
responsive to determining that the communication does not belong to a session initiated by any of the plurality of host devices that are part of the multi-host link aggregation bond, to select one of the plurality of host devices in accordance with a distribution algorithm and to direct the communication to the selected one of the plurality of host devices.

2. The apparatus of claim 1 wherein the common network address comprises an Internet Protocol (IP) address.

3. The apparatus of claim 1 wherein the distribution algorithm comprises a load balancing distribution algorithm.

4. The apparatus of claim 3 wherein the plurality of host devices which are part of the multi-host link aggregation bond provide an active-active cluster utilizing Link Aggregation Control Protocol (LACP) bond frame distribution for performing load balancing among the plurality of host devices.

5. The apparatus of claim 1 wherein the plurality of host devices are part of a clustered system, and wherein the session initiated by the given one of the plurality of host devices is utilized for communications initiated by the given one of the plurality of host devices to one or more external servers outside the clustered system.

6. The apparatus of claim 5 wherein the one or more external servers comprise at least one of a network time server, an authentication server, and an authorization server.

7. The apparatus of claim 1 wherein the at least one processing device is further configured:
to receive, by the network switch, an additional communication from one of the plurality of host devices that is part of the multi-host link aggregation bond;
to determine whether the additional communication belongs to a session initiated by said one of the plurality of host devices that is part of the multi-host link aggregation bond; and
responsive to determining that the additional communication belongs to the session initiated by said one of the plurality of host devices that is part of the multi-host link aggregation bond, to update an entry in the session store maintained by the at least one network switch for the session initiated by said one of the plurality of host devices that is part of the multi-host link aggregation bond.

8. The apparatus of claim 7 wherein updating the entry in the session store comprises updating session timeout information for the session initiated by said one of the plurality of host devices that is part of the multi-host link aggregation bond.

9. The apparatus of claim 8 wherein entries in the session store are organized in B-tree forest and doubly linked list, and wherein updating session timeout information for the session initiated by said one of the plurality of host devices that is part of the multi-host link aggregation bond comprises moving the entry to a head of the doubly linked list.

10. The apparatus of claim 1 wherein the session store maintained by the at least one network switch comprises a data structure with entries corresponding to sessions initiated by ones of the plurality of host devices that are part of the multi-host link aggregation bond.

11. The apparatus of claim 10 wherein each of the entries in the data structure is associated with a session identifier for one of the sessions initiated by one of the plurality of host devices that are part of the multi-host link aggregation bond and specifies a host-specific port for that session.

12. The apparatus of claim 11 wherein each of at least a subset of the plurality of host devices is associated with a unique port range comprising ports available for use in sessions initiated by that host device.

13. The apparatus of claim 10 wherein the at least one processing device is further configured to remove one or more entries from the data structure corresponding to sessions initiated by ones of the plurality of host devices that are part of the multi-host link aggregation bond which have timed out.

14. The apparatus of claim 13 wherein entries in the session store are organized in a B-tree forest and doubly linked list with nodes sorted by timestamp of most recent activity, and wherein removing the one or more entries from the data structure corresponding to sessions initiated by ones of the plurality of host devices that are part of the multi-host link aggregation bond which have timed out comprises parsing the data structure beginning with a tail node of the doubly linked list having a least recent timestamp.

15. A computer program product comprising a non-transitory processor-readable storage medium having stored therein program code of one or more software programs, wherein the program code when executed by at least one processing device causes the at least one processing device:
to receive, by at least one network switch, a communication to be distributed utilizing a link aggregation bond coupling the at least one network switch to a multi-host link aggregation bond associated with a plurality of host devices sharing a common network address;
to determine, utilizing a session store maintained by the at least one network switch, whether the communication belongs to a session initiated by any of the plurality of host devices that are part of the multi-host link aggregation bond;
responsive to determining that the communication belongs to a session initiated by a given one of the plurality of host devices that is part of the multi-host link aggregation bond, to retrieve a port number associated with the given host device from the session store and to distribute the communication to the given host device utilizing the retrieved port number; and
responsive to determining that the communication does not belong to a session initiated by any of the plurality of host devices that are part of the multi-host link aggregation bond, to select one of the plurality of host devices in accordance with a distribution algorithm and to direct the communication to the selected one of the plurality of host devices.

16. The computer program product of claim 15 wherein the plurality of host devices are part of a clustered system, and wherein the session initiated by the given one of the plurality of host devices is utilized for communications initiated by the given one of the plurality of host devices to one or more external servers outside the clustered system.

17. The computer program product of claim 15 wherein the session store maintained by the at least one network switch comprises a data structure with entries corresponding to sessions initiated by ones of the plurality of host devices that are part of the multi-host link aggregation bond, and wherein each of the entries in the data structure is associated with a session identifier for one of the sessions initiated by one of the plurality of host devices that are part of the multi-host link aggregation bond and specifies a host-specific port for that session.

18. A method comprising:
receiving, by at least one network switch, a communication to be distributed utilizing a link aggregation bond coupling the at least one network switch to a multi-host link aggregation bond associated with a plurality of host devices sharing a common network address;
determining, utilizing a session store maintained by the at least one network switch, whether the communication belongs to a session initiated by any of the plurality of host devices that are part of the multi-host link aggregation bond;
responsive to determining that the communication belongs to a session initiated by a given one of the plurality of host devices that is part of the multi-host link aggregation bond, retrieving a port number associated with the given host device from the session store and distributing the communication to the given host device utilizing the retrieved port number; and
responsive to determining that the communication does not belong to a session initiated by any of the plurality of host devices that are part of the multi-host link aggregation bond, selecting one of the plurality of host devices in accordance with a distribution algorithm and directing the communication to the selected one of the plurality of host devices;
wherein the method is performed using at least one processing device comprising a processor coupled to a memory.

19. The method of claim 18 wherein the plurality of host devices are part of a clustered system, and wherein the session initiated by the given one of the plurality of host devices is utilized for communications initiated by the given one of the plurality of host devices to one or more external servers outside the clustered system.

20. The method of claim 18 wherein the session store maintained by the at least one network switch comprises a data structure with entries corresponding to sessions initiated by ones of the plurality of host devices that are part of the multi-host link aggregation bond, and wherein each of the entries in the data structure is associated with a session identifier for one of the sessions initiated by one of the plurality of host devices that are part of the multi-host link aggregation bond and specifies a host-specific port for that session.
